(19) United States
(12) Patent Application Publication
(10) Pub. No.: US 2013/0028152 A1
(43) Pub. Date: Jan. 31, 2013

(54) WIRELESS ACCESS POINT WITH MODULAR NETWORK ELEMENTS

(71) Applicants: Insung KIM, Irvine, CA (US); Nicola GIROTTI, Copenhagen (DK); Jonathan Timothy LISTER, Copenhagen (DK); Siddhartha DATTAGUPTA, Irvine, CA (US); Eu Chong SON, Aliso Viejo, CA (US)

(72) Inventors: Insung KIM, Irvine, CA (US); Nicola GIROTTI, Copenhagen (DK); Jonathan Timothy LISTER, Copenhagen (DK); Siddhartha DATTAGUPTA, Irvine, CA (US); Eu Chong SON, Aliso Viejo, CA (US)

(21) Appl. No.: 13/190,305

(22) Filed: Jul. 25, 2011

(51) Int. Cl. H04W 88/08

(52) U.S. Cl. 370/310

(57) ABSTRACT

A wireless access point (AP) has a modular architecture, where each network element module provides one or more added capabilities to the wireless AP, such as devices and/or services. The modular and mechanically interlocking structure of the wireless AP enables a network user to easily expand or otherwise modify a home wireless network in a simplified manner by physically adding or removing specific network element modules. Each network element module includes the requisite power, high-speed digital signal, and module control connections in an integrated connection port, and is already loaded with suitable software for devices included in the network module element. Consequently, the network user can expand the smart network with a desired functionality by simply plugging the desired network element module into the wireless AP, and all connection and network association procedures are carried out automatically.

### TECHNICAL FIELD

Embodiments of the present invention relate generally to wireless networks and, more specifically, to a wireless access point with modular network elements.

### DESCRIPTION OF THE RELATED ART

Home networks, in which multiple computing and/or peripheral devices are communicatively linked together in a consumer's home, are becoming increasingly ubiquitous. A home environment may include one or more computers, a wireless router, a DSL modem, and one or more other client devices capable of connecting to the home network. Conventionally, each device in the home network must be individually configured to connect to the network and, once configured, may then communicate with each of the other devices attached to the home network.

In practice, procedures for installing and associating client devices and provisioning services on a home network are typically too involved for the majority of home network users to implement reliably. For example, in order to configure client devices to communicate on a home network, a network user may need to manually reconfigure the home network router, determine a network IP address and/or hostname for each client device, establish network credentials, register the various services for each device, and manually track which network IP address is associated with which client device or service. In addition, the network user is also required to manage the various power supplies, cable harnesses, and other hard-wired connections for the different components making up the network.

The involved configuration procedures described above make it a challenge for unsophisticated users to reliably setup a home network and associate client devices or services on the home network. Accordingly, there is a need in the art for systems and methods that enable the user of a home network to conveniently and securely connect one or more devices or services to a home network.

### BRIEF DESCRIPTION OF THE DRAWINGS

So that the manner in which the above recited features of the present invention can be understood in detail, a more particular description of the invention may be had by reference to example embodiments, some of which are illustrated in the appended drawings. It is to be noted, however, that the appended drawings illustrate only example embodiments of this invention and are therefore not to be considered limiting of its scope, for the invention may admit to other equally effective embodiments.

FIG. 1A is an exemplary illustration of an overarching network system configured to implement one or more aspects of the present invention.

FIG. 1B illustrates the smart home network of FIG. 1A, according to one example embodiment of the present invention.

FIG. 1C illustrates the smart home network of FIG. 1A, according to another example embodiment of the present invention.

FIG. 1D illustrates the smart home network of FIG. 1A, according to yet another example embodiment of the present invention.

FIG. 1E is a more detailed illustration of the smart network host device of FIG. 1A, according to one example embodiment of the present invention.

FIG. 1F illustrates a system software architecture for the smart network host device of FIG. 1E, according to one example embodiment of the present invention.

FIG. 2 illustrates a configuration of a wireless access point (AP) having modular network elements, according to an example embodiment of the invention.

FIG. 3 illustrates a base module according to one example embodiment of the invention.

FIG. 4 illustrates one configuration of a network element module, according to one example embodiment of the invention.

FIG. 5 illustrates a base module with a remote power supply unit that generates DC power for the base module and any network element modules coupled thereto, according to an example embodiment of the invention.

FIG. 6 illustrates a wireless AP configured with a base module and a power supply unit that is external to the base module and is configured as a network element module, according to an example embodiment of the invention.

FIG. 7 illustrates the wireless AP in FIG. 6 with a supplemental power supply unit, according to another example embodiment of the invention.

FIG. 8 illustrates a smart network in which one or more client devices are each configured as an array of multiple network element modules, according to an example embodiment of the invention.

FIG. 9 illustrates a smart network 902 in which one or more client devices are connected to the smart network 902 with power line networking capability, according to an example embodiment of the invention.

For clarity, identical reference numbers have been used, where applicable, to designate identical elements that are common between figures. It is contemplated that features of one example embodiment may be incorporated in other example embodiments without further recitation.

### DESCRIPTION OF EXAMPLE EMBODIMENTS

In the following description, numerous specific details are set forth to provide a more thorough understanding of various example embodiments of the invention. However, it will be apparent to one of skill in the art that certain embodiments of the invention may be practiced without one or more of these specific details. In other instances, well-known features have not been described in order to avoid obscuring the invention.

### Overview

One example embodiment of the present invention sets forth a network apparatus that includes a network host device and an integrated connection port. The network host device is enclosed in a housing and configured to transmit network data packets between an external network and other devices within a local wireless network, and the integrated connection port is disposed on a surface of the housing and includes a plurality of connectors for transmitting and receiving high-speed digital signals, power, and control signals in parallel.

Another example embodiment of the present invention sets forth a system that includes a first network module stack and a second network module stack. The first network module stack includes a power supply unit and a network host device. The second network module stack is located remotely from the first network module stack, is wirelessly connected to the network host device, and includes a power supply unit and a network client device. At least one network module in each of the first network module stack and the second network module stack is configured with an integrated connection port that includes a plurality of connectors for transmitting and receiving high-speed digital signals, power, and control signals in parallel.

Yet another example embodiment of the present invention sets forth a network apparatus that includes a housing enclosing a network client device, a first integrated connection port, and a second integrated connection port. The first integrated connection port is disposed on a first side of the housing and is configured to connect a second network apparatus to the network apparatus. The second integrated connection port is disposed on a second side of the housing that is opposite the first side and is configured to connect a third network apparatus to the network apparatus. The first integrated connection port and the second integrated connection port each includes a plurality of connectors for transmitting and receiving high-speed digital signals, power, and control signals in parallel.

### DETAILED DESCRIPTION OF THE FIGURES

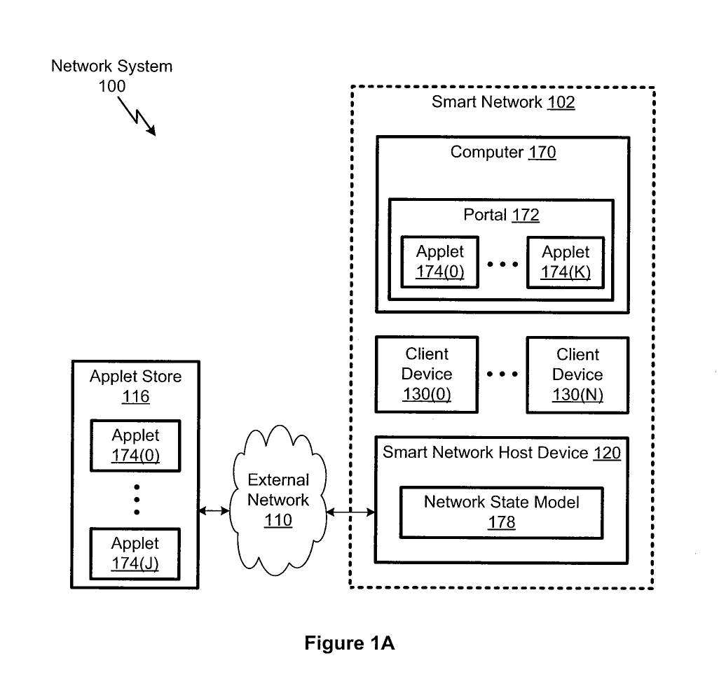

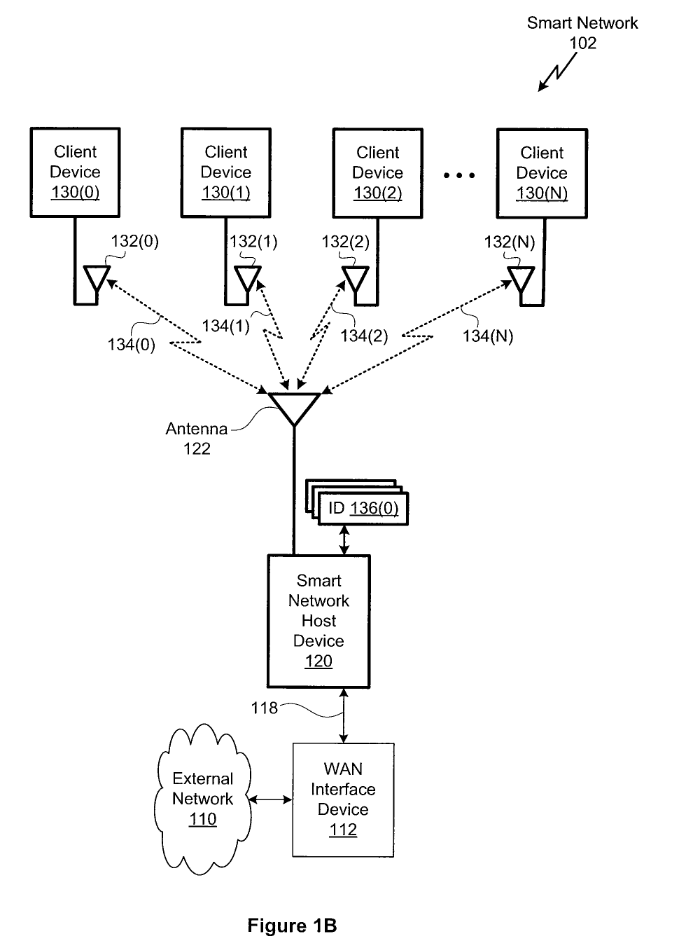

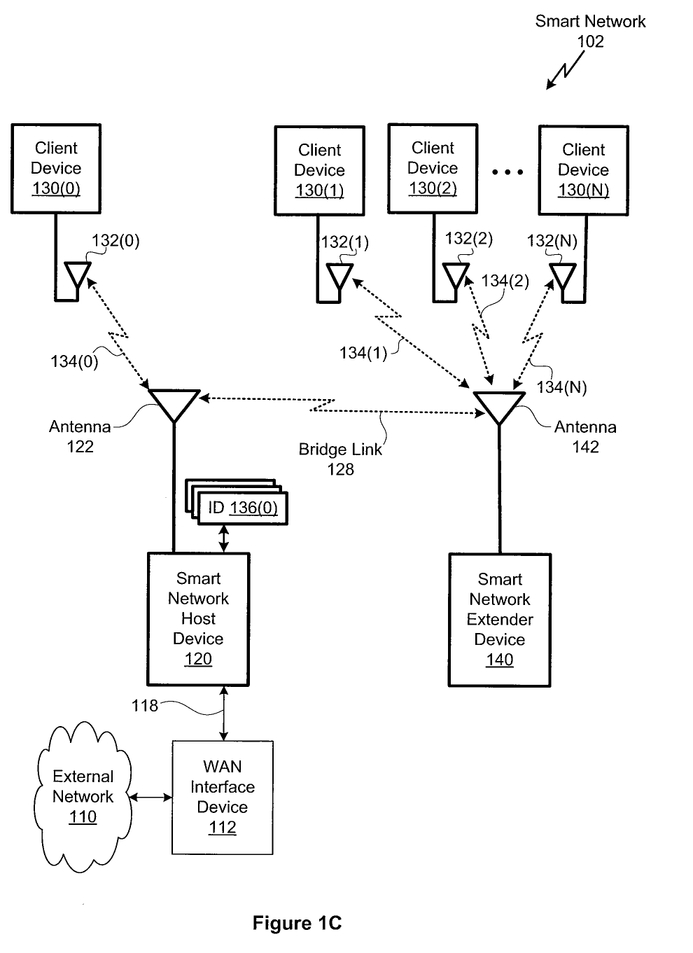

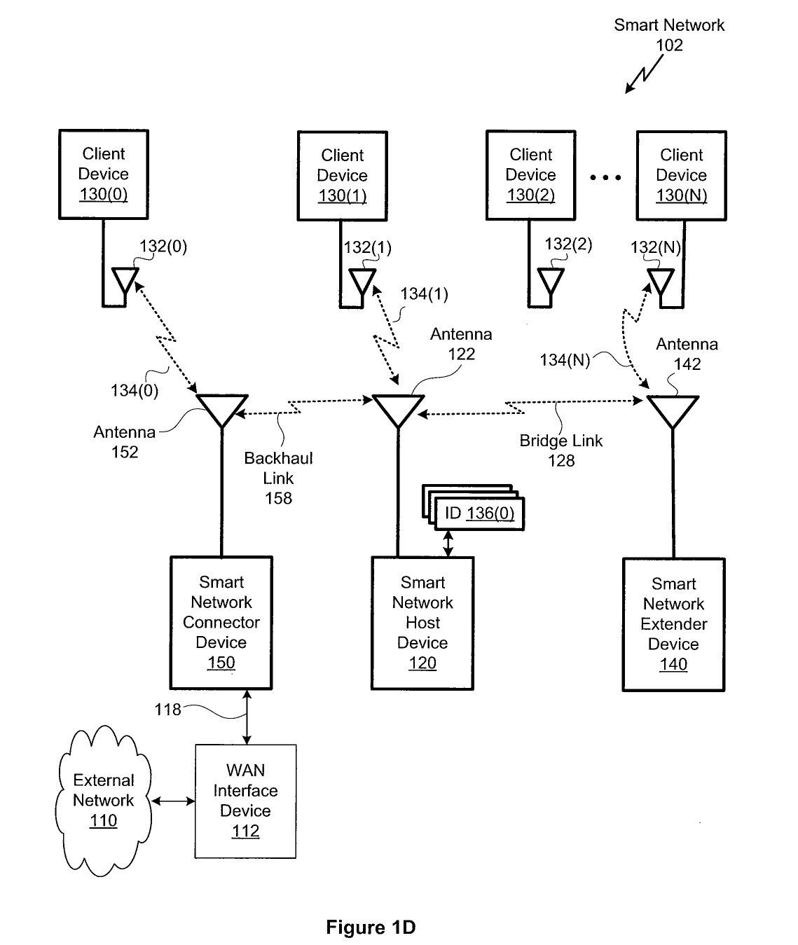

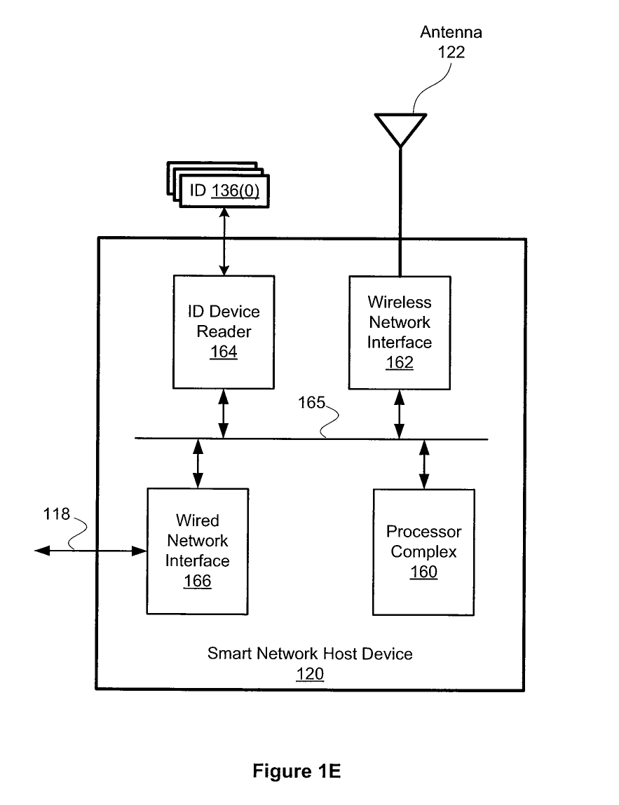

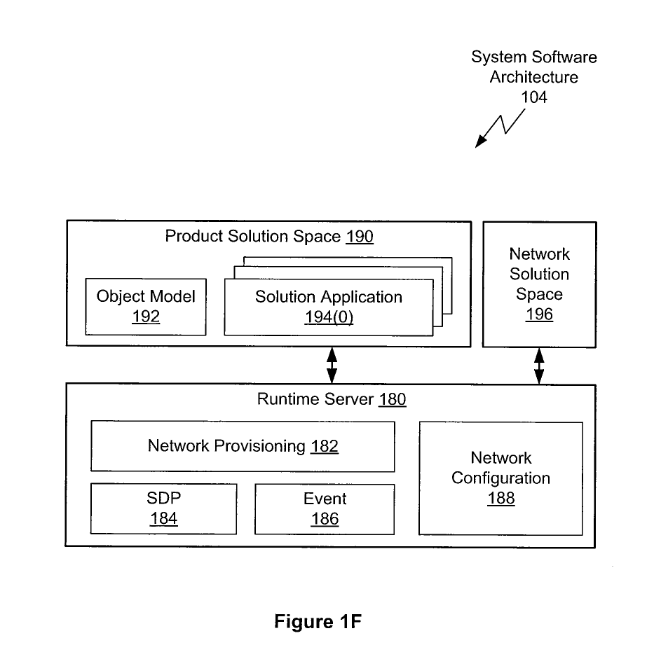

FIG. 1A is an exemplary illustration of an overarching network system 100 configured to implement one or more aspects of the present invention. The network system 100 comprises a smart network 102, an external network 110, and an applet store 116. The external network 110 may comprise the well-known Internet or any other data network system. The smart network 102 includes a smart network host device 120 configured to transmit network data packets between the external network 110 and connected devices within the smart network 102, such as computer 170 and client devices 130. Any technically feasible wireless or wired physical transport technology may be implemented to transmit the network data packets. The smart network host device 120 maintains a network state model 178 that represents the different entities and related services operating within the smart network 102. For example, if client device 130(0) implements a printer with an integrated scanner and flash memory reader, then the network state model 178 would include an entry for client device 130(0), and related attributes for a printer service, scanner service, and file (or block device) service. New devices register with the smart network host device 120, which then updates the network state model 178 to include the new device.

A portal application 172, residing within the computer 170, is configured to access the network state model 178 to determine which client devices 130 are available within the smart network 102, which services the client devices 130 provide, and to access and use the services. The portal application 172 may include one or more applets 174, configured to extend functionality of the portal application 172. A given applet 174 may be associated with a specific client device 130 and may facilitate specific usage models for the client device 130 via the extended functionality. When a new client device 130 registers with the smart network 102, a most recent version of a corresponding applet 174 may not be available within the portal application 172. However, the portal application 172 may retrieve the corresponding applet 174 or version of the corresponding applet 174 from the applet store 116.

The applet store 116 is configured to facilitate access to applets 174 by the portal application 172. The applet store 116 provides storage for applets 174 corresponding to client devices 130 and makes the applets 174 available for download to the portal application 172 via the external network 110. In one embodiment, the applet store 116 occupies a well-known location, such as a universal resource locator (URL) associated with the external network 110. Any technically feasible technique may be used to identify a particular applet 174 as corresponding to a particular client device 130. Furthermore, any technically feasible technique may be used to download the particular applet 174 an incorporate the functionality of the applet 174 to the portal 172.

FIG. 1B illustrates the smart home network 102 of FIG. 1A, according to one example embodiment of the present invention. As shown, the smart network 102 comprises a smart network host device 120, one or more client devices 130, and a wide area network (WAN) interface device 112, coupled to the external network 110 of FIG. 1A. The WAN interface device 112 may implement a cable modem, digital subscriber line (DSL) modem, fiber to the home interface, or any other technically feasible device that provides digital network connectivity to the external network 110. The WAN interface device 112 is coupled to the smart network host device 120 via a network interface 118. In one embodiment, the network interface 118 implements the well-known Ethernet standard.

The smart network host device 120 implements a wireless network interface coupled to antenna 122, which is configured to convert electrical signals to electromagnetic signals for transmitting data packets, and electromagnetic signals to electrical signals for receiving data packets. The antenna 122 may comprise plural independent radiator structures, each having a separate radiation pattern for implementing spatial multiplexing. In one embodiment, the wireless network interface implements one or more well-known standards, such as the Institute of Electrical and Electronics Engineers (IEEE) standard 802.11, which defines a system for wireless local area networking. The antenna 122 is configured establish wireless client links 134 to antennas 132 coupled to corresponding client devices 130. The smart network host device 120 implements layer 2 forwarding (bridging) for wireless data packets forwarded among client devices 130 as well as Internet protocol (IP) layer 3 routing between an IP domain associated with the smart network 102 and the external network 110. In this configuration, the smart network host device 120 provides related services and protocols, such as dynamic host configuration protocol (DHCP), network address translation (NAT), and the like.

The smart network host device 120 acts as a central authentication authority for the smart network 102 and implements authentication services for devices registering with the smart network 102. In one embodiment, authentication is implemented via Identification (ID) devices 136 that are uniquely paired with corresponding client devices 130. For example, client device 130(0) may be uniquely paired with ID device 136(0) by a manufacturer of the client device 130(0). An ID device 136(0) is physically presented to the smart network host device 120 as an authentication credential to allow a client device 130(0) paired to the ID device 136(0) to join the smart network 102. Furthermore, the client device 130(0) is able to authenticate the smart network 102 as a trusted network by accessing credentials for the corresponding ID device 136(0) specifically via the smart network 102. In one embodiment, the ID devices 136 are implemented as near field radio frequency identification (RFID) tags. Each one of the RFID tags is configured to retain authentication credentials necessary to uniquely associate the one RFID tag with one instance of the client device 130. In this way, an RFID tag may be paired with a given client device 130. Persons skilled in the art will recognize that any technique may be implemented to generate and represent authentication credentials without departing the scope and spirit of the present invention. For example, in another embodiment, the ID devices 136 could be implemented as a physical token that includes a printed bar code on a face of the token. The bar code may encode authentication credentials for a corresponding client device 130. In such an embodiment, the smart network host device 120 may include an optical scanner capable of reading the printed bar code from the physical token. In alternative embodiments, other forms of ID devices 136 may implement storage of the authentication credentials. For example, a universal serial bus (USB) storage device may be used to present authentication credentials to the smart network host device 120 for authenticating a related device, such as the computer 170. In other alternative embodiments, a user may manually authenticate a client device 130 with the smart network host device 120. For example, the user may log onto a management web page generated by the smart network host device 120 and manually enter authentication credentials, such as a printed code associated with the client device 130.

In one usage scenario involving ID device 136, the user wishes to add a new device, such as a smart network-enabled printer to the smart network 102. The printer includes an ID device 136 implemented as an RFID tag that is paired to the printer. The user places the ID device 136 in close physical proximity to the smart network host device 120, which is the able to read the ID device 136 and authenticate the printer. The printer registers with the smart network host device 120 and is then available for use by devices connected within the smart network 102. Upon successfully reading the ID device 136, the smart network host device 120 may indicate success to the user by flashing a light-emitting diode (LED), or by generating any technically feasible indication.

FIG. 1C illustrates the smart home network 102 of FIG. 1A, according to another example embodiment of the present invention. Here, the smart network 102 comprises a smart network host device 120, a smart network extender device 140, one or more client devices 130, and a wide area network (WAN) interface device 112, coupled to the external network 110 of FIG. 1A. The WAN interface device 112, smart network host device 120, and one or more client devices 130 are configured to operate as previously described in FIG. 1B.

In addition to previously described functionality, the smart network host device 120 is also configured to detect one or more smart network extender devices 140 and to establish a bridge link 128 to each of the one or more smart network extender devices 140. Each smart network extender device 140 is configured to act as a network bridge between a client device 130 and the smart network host device 120. For example, client devices 130(1) through 130(N) may be physically located such that they are able to connect to the smart network extender device 140, but not to the smart network host device 120. Furthermore, the smart network extender device 140 is able to connect to the smart network host device 120 via bridge link 128. Data packets transmitted by client devices 130(1) through 130(N) and destined to the external network 110 are received by the smart network extender device 140 and retransmitted by the smart network extender device 140 via bridge link 128 to the smart network host device 120, which then forwards the data packets to the external network 110. Similarly, data packets from the external network 110 that are destined to any of the client devices 130(1) through 130(N) are transmitted via bridge link 128 to the smart network extender device 140, which retransmits the data packets via wireless client links 134(1)-134(N). Persons skilled in the art will understand that wireless client links 134(1)-134(N) may each be configured to operate on a separate channel or band, or a common channel or band. Furthermore, bridge link 128 may operate on a separate channel or band with respect to the wireless client links 134.

In one embodiment, each smart network extender device 140 is paired to an ID device 136, which is presented as an authentication credential to the smart network host device 120 to enable the smart network extender device 140 to participate within the smart network 102.

FIG. 1D illustrates the smart home network 102 of FIG. 1A, according to yet another example embodiment of the present invention. Here, the smart network 102 comprises a smart network host device 120, a smart network extender device 140, one or more client devices 130, a smart network connector device 150, and a wide area network (WAN) interface device 112, coupled to the external network 110 of FIG. 1A. The WAN interface device 112, smart network extender device 140, and one or more client devices 130 are configured to operate as previously described in FIGS. 1B and 10.

In this embodiment, the smart network host device 120 is configured to operate similarly with respect to FIGS. 1B and 1C. However, upon detecting the smart network connector device 150, the smart network host device 120 is configured to operate as a bridge rather than a router, and the smart network connector device 150 is configured to operate as a router. A backhaul link 158 is established between the smart network host device 120 and the smart network connector device 150.

Network data traffic between client device 130(N) and the external network 110 traverses wireless client link 134(N), bridge link 128, and backhaul link 158. This network data traffic is also forwarded by smart network extender device 140, smart network host device 120, and smart network connector device 150. A client device 130 may connect directly to any one of the network extender device 140, smart network host device 120, or smart network connector device 150. As shown, client device 130(0) is connected to smart network connector device 150 via wireless client link 134(0), client device 130(1) is connected to smart network host device 120 via wireless client link 134(1), and client device 130(N) is connected to smart network extender device 140 via wireless client link 134(N).

In one embodiment, the smart network connector device 150 is paired to an ID device 136, which is presented as an authentication credential to the smart network host device 120 to enable the smart network connector device 150 to participate within the smart network 102. In an alternative embodiment, the smart network connector device 150 and the smart network host device 120 are paired during a manufacturing step, eliminating the need for a separate ID device 136.

FIG. 1E is a more detailed illustration of the smart network host device 120 of FIG. 1A, according to one example embodiment of the present invention. As shown, the smart network host device 120 comprises a processor complex, 160, a wireless network interface 162, an ID device reader 164, and a wired network interface 166. An interconnect 165 is configured to transmit data among the processor complex 160, wireless network interface 162, ID device reader 164, and wired network interface 166. The wired network interface 166 is configured transmit data packets via network interface 118, based on data received via the interconnect 165. The wired network interface 166 is also configured to receive data packets from the network interface 118 and transmit contents of the received data packets to the processor complex 160 via the interconnect 165. The wireless network interface 162 is configured to transmit data packets, based on data received via the interconnect 165, to one or more network devices within range. The wireless network interface 162 is also configured to receive data packets from the one or more network devices and then transmit contents of the received packets to the processor complex 160. The wireless network interface 162 is coupled to an antenna 122.

The processor complex 160 comprises a central processing unit (CPU), non-volatile memory for storing persistent programs, program state, and configuration information, random access memory (RAM) for storing temporary or volatile data, and an interface to the interconnect 165. In one embodiment, the processor complex 160 is configured to execute an operating system and applications that provide routing services. The routing services may include, for example, data packet forwarding between the network interface 118 and the wireless network interface 162. The packet forwarding services may include, without limitation, bridging among the one or more network devices via the wireless network interface 162.

The ID device reader 164 is configured to read data from an associated ID device 136. In one embodiment, the ID device reader 164 is configured to read data from RFID tags comprising the ID device 136. The ID device reader 164 may also include a USB reader. In another embodiment, the ID device reader 164 may be implemented as an optical scanner for reading ID devices 136 that encode data via a printed bar code. In yet other embodiments, the ID device reader 164 may be configured to read data from other types of interfaces, such as other types of flash memories like an SD flash card.

In certain embodiments, the smart network host device 120 comprises one or more integrated circuits that implement respective functions of the smart network host device 120. For example, the processor complex 160, wired network interface 166, and wireless network interface 162 may be integrated into a single integrated circuit.

Persons skilled in the art will recognize that the smart network extender device 140 may be implemented using the basic architecture of the smart network host device 120, with the exception that the ID device reader 164 and wired network interface 166 are not required for the smart network extender device 140. Similarly, the smart network connector device 150 may be implemented using the basic architecture of the smart network host device 120, with the exception that the ID device reader 164 is not required for the smart network connector device 150.

FIG. 1F illustrates a system software architecture for the smart network host device 120 of FIG. 1E, according to one example embodiment of the present invention. As shown, the software architecture 104 includes several software modules within the smart network host device 120. Programming instructions stored within the processor complex 160 implement a portion of the system software architecture 104 that includes a runtime server 180, a product solution space 190, and a network solution space 196. The product solution space 190 comprises an object model 192 and one or more solution applications 194. The object model 192 provides a standard, consistent abstraction of different network elements and related services within the smart network 102. Exemplary network elements include devices coupled to the smart network 102, such as printers, cameras, and display devices. Exemplary services include device and service discovery, event tracking and generation, and state presentation for the different elements. In one embodiment, the object model 192 includes a network interface based on the well-known extensible markup language (XML). One or more solution applications 194 provide specific functionality, such as a specific view of a storage system, or a specific technique for presenting certain data. The network solution space 196 includes software modules configured to provide management of network elements and network services, including device services, local area network services within the smart network 102, and wide area network services related to connectivity management of the external network 110.

The runtime server 180 comprises a network provisioning module 182, a service and discovery provisioning (SDP) module 184, an event module 186, and a network configuration module 188. The event module 186 tracks different network events, such as a network device advertising presence or updating status within the smart network 102. The SDP module 184 maintains a persistent view of different network devices and related services, based on data from the event module 186 and on data from the network devices. The network provisioning module 182 provides authentication and authorization for network devices within the smart network 102. Authentication credentials may be presented via a given ID device 136. The network provisioning module 182 may also facilitate certain network services, such as DHCP leases. The network configuration module 188 includes hardware platform-specific implementation methods for network configuration and management. The persistent view comprises the network state model 178 of FIG. 1A.

Persons skilled in the art will recognize that the smart network connector device 150 and smart network extender device 140 may be implemented using an appropriate subset of the system software architecture 104 described above in conjunction with FIG. 1F.

Embodiments of the invention contemplate a wireless access point (AP) having a modular architecture, where each network element module of the modular architecture provides added capability, i.e., devices and/or services, to the wireless AP. The wireless AP may be incorporated into a wireless network, such as the smart network 102, and generally includes the smart network host device 120. The modular and mechanically interlocking structure of the wireless AP enables a network user to easily expand or otherwise modify a home wireless network in a simplified manner by physically adding or removing specific network element modules. Each network element module includes the requisite power, high-speed digital signal, and module control connections in an integrated connection port, and is already loaded with suitable software for devices included in the network module element. Consequently, the network user can expand the smart network with a desired functionality by simply plugging the desired network element module into the wireless AP, and all connection and network association procedures are carried out automatically.

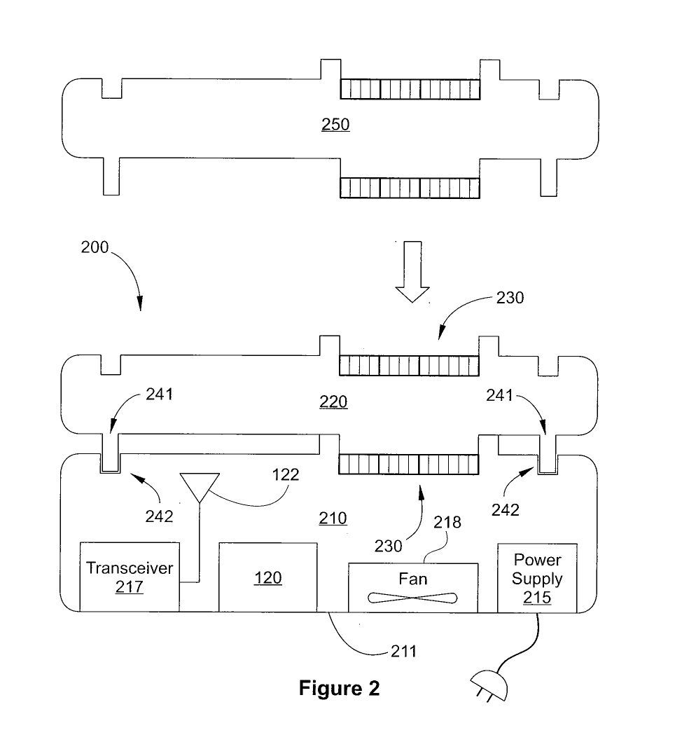

FIG. 2 illustrates a configuration of a wireless AP 200 having modular network elements, according to an example embodiment of the invention. Wireless AP 200 includes a base module 210 and one or more network element modules 220. As shown, the network element modules 220 are coupled to base module 210 in series to form a vertical stack of modules. The network element modules 220 are coupled to base module 210 and to each other via an integrated connection port 230, which includes a plurality of electrical connectors for carrying high-speed digital signals, power, and control signals between the connected network element modules 220 and the base module 210. In some embodiments, the network element modules 220 and the base module 210 are also physically coupled to each other via mechanically interlocking components, such as projections 241 and sockets 242, to enhance the structural integrity of the vertical stack of modules. A user may couple supplemental network modules 250 to the wireless AP 200 to provide additional functionality to the wireless AP 200 when desired. In some embodiments, base module 210, the network element modules 220, and the supplemental network elements 250 are configured to form a horizontal array rather than the vertical array illustrated in FIG. 2. In such an embodiment, the wireless AP 200 can be conveniently located on a book shelf or other horizontal surface, even when wireless AP 200 includes a large number of network element modules 220.

The network element modules 220 facilitate the “plug-and-play” addition of devices, services, and software to the wireless AP 200. Specifically, when a network element module 220 is added to the wireless AP 200, all requisite power, control, and digital signal connections are made between the newly added network element module 220 and the base module 210 using mating integrated connection ports 230. In addition, devices included in a new network element module 220 automatically register with the smart network host device 120, which then updates the network state model 178 in FIG. 1A to include the new device. Consequently, network associations and authorizations are performed without user participation whenever a new network element module 220 is coupled to the wireless AP 200 via an integrated connection port 230.

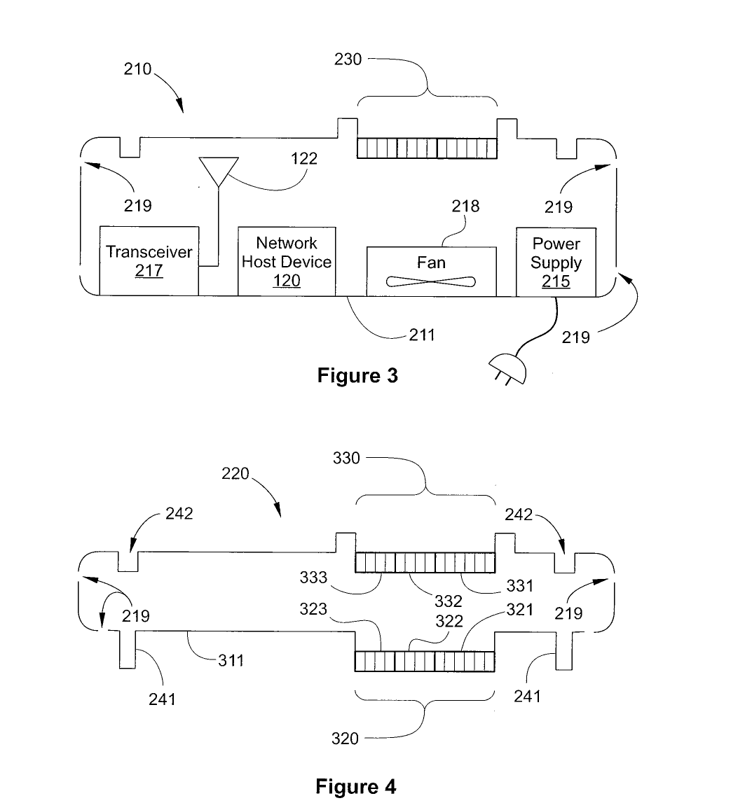

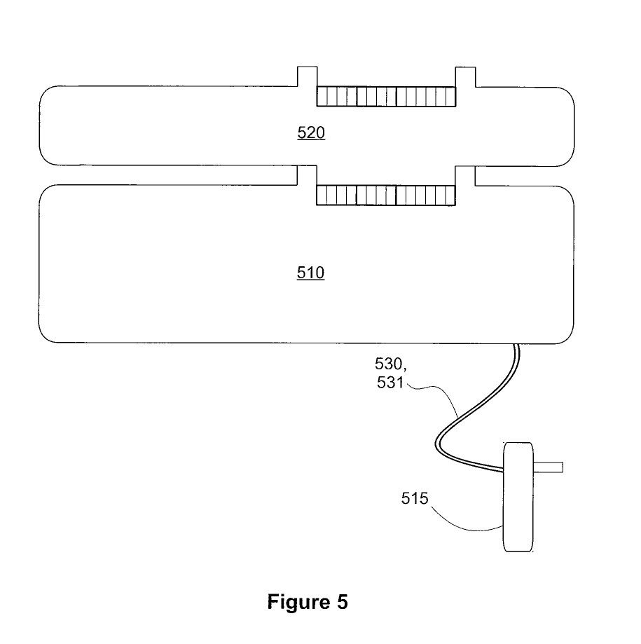

FIG. 3 illustrates the base module 210 according to one example embodiment of the invention. In some embodiments, the base module 210 acts as a structural support for the wireless AP 200 to which additional network element modules can be added, and includes a housing 211 that encloses a network host device, such as the smart network host device 120. In the embodiment illustrated in FIG. 2, base module 210 also includes a power supply unit 215, a transceiver 217 for the smart network host device 120, and the antenna 122 for the smart network host device 120. In other embodiments, the transceiver 217 and/or the antenna 122 may be located in one of network element modules 220. For example, in one embodiment, the antenna 122 can be located in the top network element module 220 of the wireless AP 200 to ensure that the antenna 122 is unobstructed by other network element modules 220. In another embodiment, the antenna 122 is disposed in the base module 210 and the base module 210 is positioned at the top of the network module stack making up the wireless AP 200. Additional configurations of the base module 210 are described below in conjunction with FIGS. 5-7.

In some embodiments, the housing 211 of the base module 210 includes a plurality of air vents 219 to allow free convective air flow through the housing 211 to cool internal components, such as the power supply unit 215 and the smart network host device 120. In such an embodiment, a portion of the air vents 219 may be disposed in a lower region of the housing 211 and a remaining portion of the air vents 210 may be disposed in an upper portion of the housing 211. In some embodiments, the base module 210 may further include a fan 218 to provide forced convective cooling of internal components.

FIG. 4 illustrates one configuration of a network element module 220, according to one example embodiment of the invention. In this example embodiment, the network element module 220 includes a housing 311 with projections 241 located on one side of the housing 311 and complementary sockets 242 located on an opposite side of the housing 311, as shown. The projections 241 are configured to mechanically interlock with the complementary sockets 242 on an adjacent network element module 220. In some embodiments, air vents 219 are formed in the housing 311 to enhance cooling of internal components. In addition, the network element module 220 includes a first integrated connection port 320 disposed on one side of the housing 311 and a second integrated connection port 330 disposed on an opposite side of the housing 311. The first integrated connection port 320 and the second integrated connection port 330 are configured with complementary connector types, so that the first integrated connection port 320 on one network element module 220 is configured to connect to a second integrated connection port 330 on an adjacent network element module 220, and vice-versa. For example, in one embodiment, the first integrated connection port 320 comprises a socket-based connector and the second integrated connection port 330 comprises a pin-based connector.

First integrated connection port 320 includes a DC power connector 321, a high-speed digital signal connector 322, and a control signal connector 323. Similarly, second integrated connection port 330 includes a DC power connector 331, a high-speed digital signal connector 332, and a control signal connector 333. The DC power connectors 321, 331 include conductors and connectors configured to transmit DC power at one or more voltages to the network element modules 220 added to the wireless AP 200. The high-speed digital signal connectors 322, 332 include conductors and connectors configured to transmit and receive high-speed digital signals to and from the network element modules 220 added to wireless AP 200. For example, in some embodiments, the high-speed digital signal connectors 322, 332 are configured to transmit and receive multiple universal serial bus (USB) 2.0 signals, multiple Ethernet signals, or a combination of both. The control signal connectors 323, 333 include conductors and connectors configured to transmit and receive control signals for controlling the network element modules 220 added to the wireless AP 220. In some embodiments, such control signals include at least one of serial peripheral interface (SPI) protocol signals, inter-integrated circuit (I²C) protocol signals, power control signals, plug detection signals, and the like.

In some embodiments, the wireless AP 200 includes a network element module 220 configured with one or more devices that provide additional functionality to the wireless AP 200. Suitable devices that can be incorporated into a network element module 220 include high-volume data storage devices, such as a hard disk drive or solid state memory device, digital signal switches, such as a multi-port Ethernet or USB switch, an antenna and/or transceiver for the smart network host device 120, such as a 5 GHz WiFi device, a home audio receiver, an audio-video receiver, and the like. To facilitate plug-and-play expansion of the wireless AP 200, a network element module that includes such a device also may include drivers and other software associated the device.

In some embodiments, the wireless AP 200 includes a network element module 220 configured with a combination of hardware and software to provide additional functionality to the wireless AP 200. For example, in one embodiment, a network module 220 is configured with a parental control system and/or other service that may include both hardware and software components. In another embodiment, a network module 220 is configured to include a video game console. In such an embodiment, auxiliary software associated with the video game console may also be included in the network module. In yet other embodiments, a network module 220 may include only a software enhancement for the wireless AP 200. In such an embodiment, attachment of the network module 220 may only be required temporarily for installation of the desired software and then the network module 220 may be removed. Alternatively, the software-containing network module 220 may be left in place in the wireless AP 200 to indicate the presence of the associated software.

Embodiments of the invention contemplate various configurations of the base module and power supply unit. In FIG. 2, the wireless AP 200 is illustrated with a base module 210 that includes an internal power supply unit, i.e., the power supply unit 215. FIG. 5 illustrates a base module 510 with a remote power supply unit 515 that generates DC power remotely for the base module 510 and any network element modules 520 coupled thereto, according to an example embodiment of the invention. The remote power supply unit 515 is disposed outside the base module 510, is configured for use with a conventional AC power source, such as a 120V household wall outlet, and provides DC power to the base module 510 via a power cable 530. In such an embodiment, the base module 510 can be positioned a significant distance from the AC power source, thereby minimizing potential AC interference with the smart network host device 120 and reducing heat generated in the base module 510. In one embodiment, the power cable 530 also includes an Ethernet cable 531 configured to carry Ethernet signals to the base unit 510 from a hard-wired link to the WAN interface device 112, the latter of which is described above in conjunction with FIG. 1B.

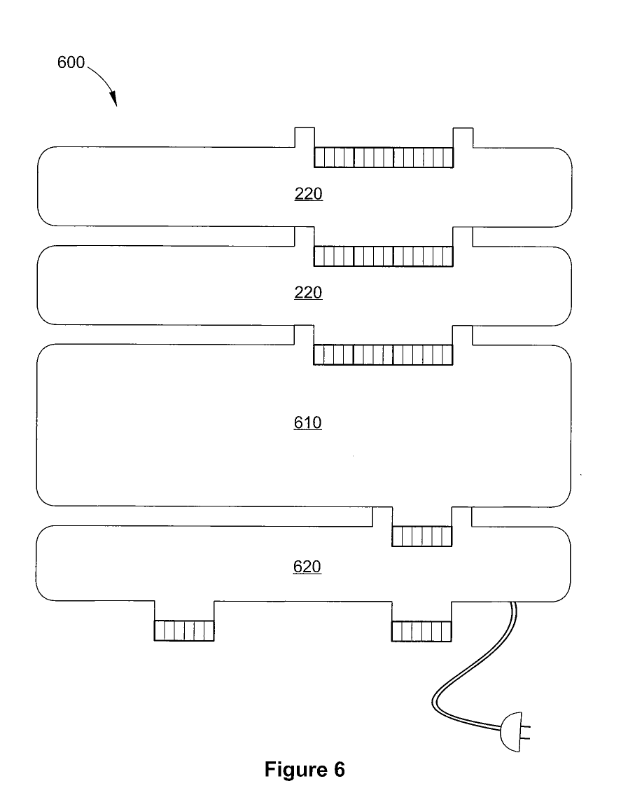

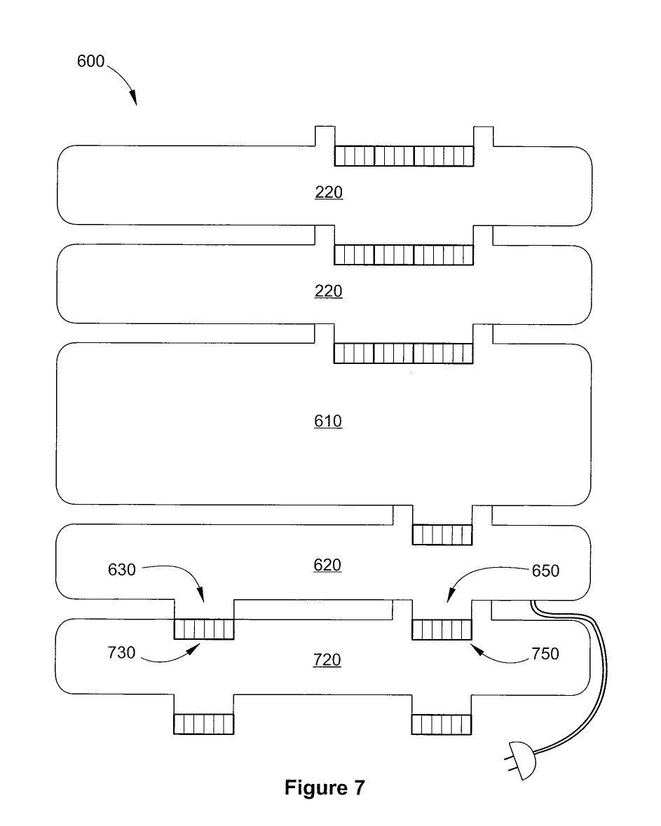

FIG. 6 illustrates a wireless AP 600 configured with a base module 610 and a power supply unit 620 that is external to the base module 610 and is configured as a network element module, according to an example embodiment of the invention. Because the power supply unit 620 is external to the base module 610, heat generated in the base module 610 is reduced, since DC power provided to the base module 610 and the plurality of network element modules 220 included in the wireless AP 600 is generated outside of the base module 610. In addition, the power supply unit 620 may be configured so that one or more supplemental power supply units can be added to the wireless AP 600 in a modular fashion. FIG. 7 illustrates the wireless AP 600 in FIG. 6 with a supplemental power supply unit 720, according to another example embodiment of the invention. As shown, the supplemental power supply unit 720 is coupled to the power supply unit 620 to provide additional power DC power to the plurality of network element modules 220 included in the wireless AP 600. A DC power connection 750 in the supplemental power supply unit 720 mates with a complementary DC power connection 650 in the power supply unit 620, so that the DC power generated by the supplemental power supply unit 720 is carried to the power supply unit 620 via the DC power connections 650, 750. In such an embodiment, the supplemental power supply 720 may be configured with an AC power connection 730 that mates with a complementary AC power connection 630 in the power supply unit 620. The AC power connections 630, 730 provide AC power to the supplemental power supply unit 720 via the power supply unit 620, obviating the need for an additional external power cable for the supplemental power supply unit 720.

Embodiments of the invention further contemplate a configuration of the smart network 102 (illustrated in FIG. 1A), in which one or more of the client devices 130(0)-130(N) are based on the modular architecture described above for the wireless AP 200. Specifically, one or more of the client device 130(0)-130(N) includes a physically interconnected array of multiple network element modules.

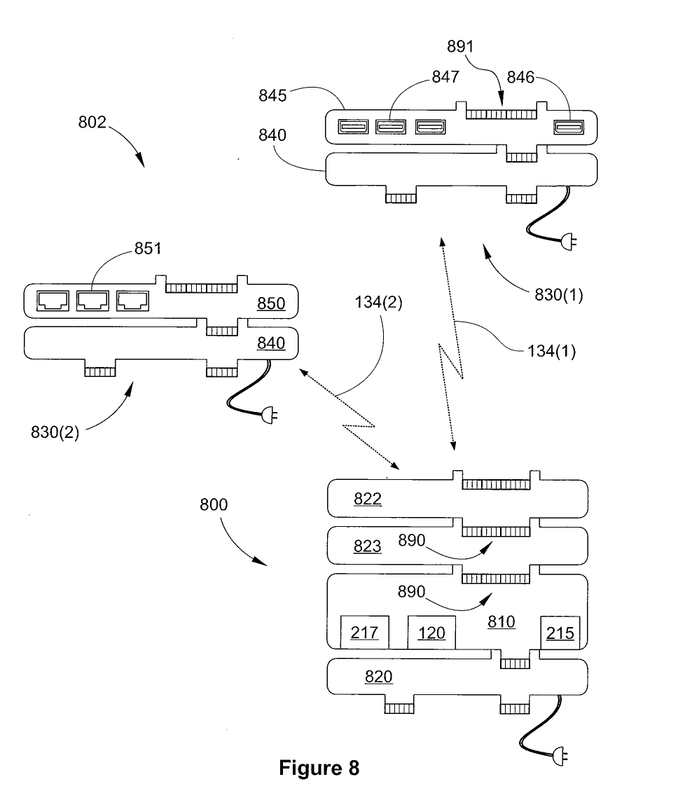

FIG. 8 illustrates a smart network 802 in which one or more client devices are each configured as an array of multiple network element modules, according to an example embodiment of the invention. The smart network 802 includes a wireless AP 800, and client devices 830(1) and 830(2). By way of example, only two of the client devices in the smart network 802 are configured as an array of multiple network element modules, but a smart network having any number of client devices so configured falls within the scope of the invention.

As shown, the wireless AP 800 and the client devices 830(1) and 830(2) each include an array of multiple network element modules. The client devices 830(1) and 830(2) may be located remotely from the wireless AP 800, e.g. in different rooms, and are connected to the smart network host device 120 in the wireless AP 800 via wireless client links 134(1) and 134(2), respectively. Generally, the wireless AP 800 and the client devices 830(1) and 830(2) are independently powered, since each may be located remotely from one another.

The wireless AP 800 includes a supplemental power supply module 820 coupled to a base module 810, which includes a smart network host device 120, an internal power supply unit 215, and a transceiver 217. The wireless AP 800 further includes an antenna module 822 and a data storage module 823. The base module 810, the supplemental power supply module 820, the antenna module 822 and the data storage module 823 are each configured as network element modules, such as the network element modules 220 in FIGS. 2 and 3, and are coupled to each other in series via integrated connection ports 890. It is noted that in other embodiments of the invention, the antenna functionality of the antenna module 822 may be incorporated into the base module 801 in lieu of the antenna module 822.

The client device 830(1) includes an external power supply module 840, and an audio-video receiver module 845. The external power supply module 840 converts AC power to DC power for the audio-video receiver module 845. The audio-video receiver module 845 is configured with a high-definition multimedia interface (HDMI) output port 846 for outputting videos to a display device, and multiple HDMI input ports 847 to facilitate the use of multiple sources for said videos. The client device 830(2) includes an external power supply module 840 and an Ethernet switch module 850 that provides a user with multiple Ethernet ports 851. As shown, the external power supply modules 840, the audio-video receiver module 845, and the Ethernet switch module 850 are each configured as network element modules, similar to the network element modules 220 in FIGS. 2 and 3.

In operation, a user of the smart network 802 can easily modify or expand the functionality of the wireless AP 800 or the client devices 830(1) and 830(2) by physically attaching the requisite network element module where desired. For example, a data storage device can be added to the client device 830(1) by simply attaching a network element module that is configured with such a storage device to the integrated connection port 891 the audio-video receiver module 845. Because the network element module is coupled to the integrated connection port 891 of the audio-video receiver module 845, all connections for power, control signals, and high-speed digital signals are made simultaneously and without any cable management on the part of the user. The storage device and any other devices incorporated into the network element module automatically register with the smart network host device 120, which then updates the network state model 178 to include the new device or devices. Thus, by simply physically coupling a new network element module to the wireless AP 800, the wireless AP 800 is immediately and automatically provided with the new functionality of the network element module with essentially no interaction or set-up procedures carried out by the user.

In some embodiments, new network element modules coupled to the wireless AP 200 in FIG. 2 can expand the networking capability of the smart network 102 to create a hybrid network infrastructure. Such a hybrid network infrastructure may include a dual-band concurrent network, a power line communication network, and/or a wireless control and monitoring network, such as a ZigBee specification home automation network.

In one embodiment, a network module coupled to the wireless AP 200 converts the smart network 102 to a dual-band concurrent network. In such an embodiment, the new network module includes a transceiver configured to operate at a different wireless signaling frequency than the primary transceiver of the wireless AP 200, i.e. the transceiver 217 in FIG. 2. For example, the transceiver 217 may be configured with 2.4 GHz Wi-Fi hardware while the new network module may be configured with 5.0 GHz Wi-Fi hardware. Once the 5 GHz Wi-Fi network module is coupled to the wireless AP 200 by the user, the smart network 102 is automatically provisioned and configured with the 5 GHz Wi-Fi capability.

In another embodiment, a new network element module coupled to the wireless AP 200 in FIG. 2 provides additional wireless control and monitoring capability to the smart network 102 to a hybrid network. In such an embodiment, the new network module is a home automation network provisioning module and includes a transceiver configured for operational compatibility for a high level communication protocol based on the IEEE 802.15.4-2003 standard for low-rate wireless personal area networks (LR-WPANs), e.g., the ZigBee specification. In such an embodiment, the wireless network 102 can be used to control a home automation network, in which electrical and electronic devices needing low rates of data transfer, such as wireless light switches, smart appliances, and the like, are controlled and/or monitored via short-range radio.

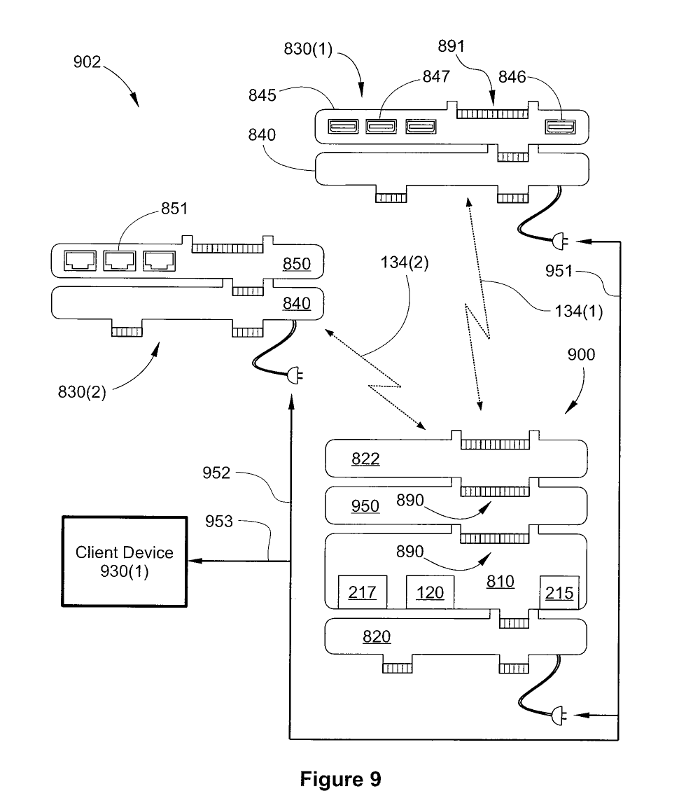

In another embodiment, a new network element module coupled to the wireless AP 200 in FIG. 2 provides the smart network 102 with power line networking capability. In such an embodiment, the smart network 102 uses existing electrical wiring to create parallel networking paths to one or more of the client devices 130(1-N). FIG. 9 illustrates a smart network 902 in which one or more client devices are connected to the smart network 902 with power line networking capability, according to an example embodiment of the invention. The smart network 902 is substantially similar in operation and organization to the smart network 802 illustrated in FIG. 8, except that the smart network 902 includes a wireless AP 900 having a power line provisioning module 950 that provides the smart network 902 with power line networking capability to client devices 830(1), 830(2), and 930(1). Power line provisioning module 950 includes hardware and software configured to provide power line networking paths to client devices 830(1), 830(2), and 930(1) in the smart network 902. As shown, the network module 950 provides parallel networking paths to client devices 830(1), 830(2) via electrical power lines 951, 952. In addition, the network module 950 provides a networking connection to the client device 930(1), which is not configured with Wi-Fi capability, via an electrical power line 953. As with other network modules described herein, when the network module 950 is coupled to the wireless AP 900, detection and provisioning of the smart network 902 occurs automatically.

In sum, example embodiments of the invention disclose a wireless AP having a modular architecture, where supplemental network element modules provide added capability, i.e., devices and/or services, to the wireless AP. Because each network element module includes the requisite power, high-speed digital signal, and module control connections in an integrated connection port, and because each network element module is already loaded with suitable software for devices included in the network module element, expansion of the wireless is greatly simplified. A network user only needs to plug a desired network element module into the wireless AP, and all connection and network association procedures are carried out automatically.

While the foregoing is directed to certain example embodiments of the present invention, other and further embodiments of the invention may be devised without departing from the basic scope thereof. Therefore, the scope of the present invention is determined by the claims that follow.

We claim:

1. A network apparatus, comprising:
a network host device enclosed in a housing and configured to transmit network data packets between an external network and other devices within a local wireless network; and
an integrated connection port disposed on a surface of the housing that includes a plurality of connectors for transmitting and receiving high-speed digital signals, power, and control signals in parallel.

2. The network apparatus of claim 1, wherein the high-speed digital signals include at least one of universal serial bus (USB) signals and Ethernet signals.

3. The network apparatus of claim 1, wherein the control signals control at least one network element module when connected to the integrated connection port.

4. The network apparatus of claim 1, further comprising a power supply unit that remotely generates DC power for the network host device.

5. The network apparatus of claim 4, wherein the power supply unit comprises a cable that transmits DC power and Ethernet signals to the network host device.

6. The network apparatus of claim 1, further comprising a power supply unit configured as a network element module and coupled to the network host device via the integrated connection port.

7. The network apparatus of claim 1, further comprising at least one additional network element module that is coupled to the integrated connection port and includes a second integrated connection port.

8. The network apparatus of claim 7, wherein the at least one additional network element module is configured to mechanically interlock with the housing that encloses the network host device.

9. The network apparatus of claim 7, wherein the at least one additional network element module comprises a data storage device, a supplemental power supply unit, an antenna for the network host device, a transceiver for the network host device, a parental control system, a home audio receiver, an audio-video receiver, a digital signal switch, a video game console, a software provisioning module, a dual-band transceiver, a power line provisioning module, or a home automation provisioning module.

10. A system, comprising:
a first network module stack that includes a power supply unit and a network host device; and
a second network module stack that is located remotely from the first network module stack, is wirelessly connected to the network host device, and includes a power supply unit and a network client device,
wherein at least one network module in each of the first network module stack and the second network module stack is configured with an integrated connection port that includes a plurality of connectors for transmitting and receiving high-speed digital signals, power, and control signals in parallel.

11. The system of claim 10, wherein the high-speed digital signals include at least one of universal serial bus (USB) signals and Ethernet signals.

12. The system of claim 10, wherein the control signals control the at least one network element module in the first network module stack or the second network module stack.

13. The system of claim 10, wherein the power supply unit included in the first network module stack remotely generates DC power for the network host device.

14. The system of claim 13, wherein the power supply unit included in the first network module stack comprises a cable that transmits DC power and Ethernet signals to the network host device.

15. The system of claim 10, wherein the power supply unit included in the first network module stack is configured as a second network element module and is coupled to the network host device of the at least one network module in the first network module stack.

16. The system of claim 10, wherein the first network module stack further includes at least one additional network module that is coupled to the integrated connection port of the at least one network module in the first network module stack and includes a second integrated connection port.

17. The system of claim 16, wherein the at least one additional network module is configured to mechanically interlock with the at least one network module in the first network module stack.

18. The system of claim 10, wherein the network client device comprises a data storage device, a supplemental power supply unit, an antenna for the network host device, a transceiver for the network host device, a parental control system, a home audio receiver, an audio-video receiver, a digital signal switch, a video game console, a software provisioning module, a dual-band transceiver, a power line provisioning module, or a home automation provisioning module.

19. A network apparatus, comprising:
a housing enclosing a network client device;
a first integrated connection port that is disposed on a first side of the housing and is configured to connect a second network apparatus to the network apparatus; and
a second integrated connection port that is disposed on a second side of the housing that is opposite the first side and is configured to connect a third network apparatus to the network apparatus,
wherein the first integrated connection port and the second integrated connection port each includes a plurality of connectors for transmitting and receiving high-speed digital signals, power, and control signals in parallel.

20. The network apparatus of claim 19, wherein the network client device comprises a data storage device, a supplemental power supply unit, an antenna for the network host device, a transceiver for the network host device, a parental control system, a home audio receiver, an audio-video receiver, a digital signal switch, a video game console, a software provisioning module, a dual-band transceiver, a power line provisioning module, or a home automation provisioning module.
